(19) United States
(12) Patent Application Publication
(10) Pub. No.: US 2006/0103568 A1
(43) Pub. Date: May 18, 2006

(54) Systems and methods for wirelessly determining vehicle identification, registration, compliance status and location

(76) Inventors: Steven W. Powell, Memphis, TN (US); Luis M. Ortiz, Albuquerque, NM (US)

Correspondence Address: Ortiz & Lopez, PLLC, P.O. Box 4484, Albuquerque, NM, 87196-4484, US

(21) Appl. No.: 10/992,374

(22) Filed: Nov. 18, 2004

(51) Int. Cl. G01S 13/74

(52) U.S. Cl. 342/42; 342/43; 342/44; 342/50; 342/58; 342/104

(57) ABSTRACT

A radar unit as a Challenger communicates with ref tag-enabled media (e.g., registration stickers, licensed plates, physical VIN tags) associated with motor vehicles to obtain vehicle-related data, e.g., vehicle identification numbers, states registration status, vehicle inspection status, insurance expiration, amber alert status, license tag/plate information and additional features are a particularly unique features of interested to government and private entities. The radar challenger can be integrated with a radar unit used by law enforcement to obtain vehicle speed in addition to vehicle-related data. Data can be transmitted over network to agencies and private entities.

### INVENTION PRIORITY

The present invention claims the benefit of U.S. Provisional Patent Application No. 60/520,869 entitled “systems and methods for wirelessly determining vehicle identification, registration, compliance status and location,” which was filed on Nov. 17, 2003.

### FIELD OF THE INVENTION

The present invention is related to: managing vehicle identification numbers (VIN), motor vehicle registrations, emission compliance, speed monitoring, radar, Rf Tag (tagging), Global positioning system (GPS) integration, location determination, motor vehicle security/retrieval, and radar initiated challenge/response of rf tags.

### BACKGROUND

For many years governmental agencies and law enforcement could only obtain from officers in the field with hand held or dash mounted radar systems the speed of a nearby vehicle. The Radar units were limited with minimal data retrieval options and could not print out text data. Currently, law enforcement agencies purchase standard speed radar units that only provide users the ability to know the speed of the vehicle that the radar device was pointed at. Agencies have not yet been able to print out speed information from the radar device onsite and on demand.

There have been many advances in technology since the advent of the “radar gun” and its use to determine a vehicle speeds. Radio frequency tagging (rf tagging) has advanced to the point that detailed digital data can be obtained from an rf tag using a radar-based transponder device. An example of such technology is best described in U.S. Pat. No. 6,577,266 issued Jun. 10, 2003 to Robert M. Axline and entitled “Transponder data processing methods and systems.” In the Axline patent, pulses from a radar cause a tag (or transponder) to respond to the radar. The radar, along with its conventional pulse transmissions, sends a reference signal to the tag. The tag recovers the reference signal and uses it to shift the center frequency of the received radar pulse to a different frequency. This shift causes the frequencies of the tag response pulses to be disjoint from those of the transmit pulse. In this way, radar clutter can be eliminated from the tag responses. The radar predicts, to within a small Doppler offset, the center frequency of tag response pulses. The radar can create synthetic-aperture-radar-like images and moving-target-indicator-radar-like maps containing the signature of the tag against a background of thermal noise and greatly attenuated radar clutter. Radar can geolocate the tag precisely and accurately (to within better than one meter of error). The tag can also encode status and environmental data onto its response pulses, and the radar can receive and decode this information.

Despite advances in radar initiated data retrieval, the “state of the art” industrial condition for law enforcement today is such that a alleged speeding violator is merely presented with a verbal indication from the arresting officer that the arrested is exceeding the speed limit.

With an more intense atmosphere in the global community following increased terrorist activity and crime, advances in motor vehicle monitoring will likely be an important feature of future technology. Such is already the case with homing devices that allow authorities to track an automobiles movement and location, register the location of criminals on probation and E911 technology in wireless communications. The abduction of children is at an all time high, location of vehicles associated with an abduction within the first 3 hours is critical to law enforcement.

The level of thefts of vehicles globally is an economic problem that is costing citizens and insurance companies billions of dollars each year. Transmitters (.e.g., a product referred to as a Lowjack) enables a paid for service to track the location of a stolen or missing automobile. Also available for many General Motors (“GM”) vehicles is the “On-Star”™ service that is used for security, communications, location identification and vehicle recovery. Furthermore, “data fueling” is being described and systems and method that will be used for vehicles to be able to receive and transmit data over networks.

Finally, many city and state governments are currently strapped with financial burdens. In the United States, there is an immediate and much needed need for additional revenue generation for local, state government agencies. Internationally, law enforcement and government can benefit from improvement in safety monitoring and new revenue streams. The present inventors believe that public revenue can vastly improve with, for example, the radar tracking of vehicle registrations, inspection status, insurance expiration. Many more vehicle applications can be envisioned.

### SUMMARY OF THE INVENTION

The invention includes methods and systems for determining the identification number (VIN), compliance status (e.g., registration, emissions), location (e.g., GPS), and speed of a motor vehicle.

In accordance with a feature of the present invention, an Rf Tag can installed alone or be embedded together with a vehicles VIN tag and/or stickers issued by authorities. In accordance with features of the present invention, the Rf Tag can receive challenges from a transceiver, and return data in response to the challenge.

In accordance with a method of the present invention, a “Challenger” transmits a radio frequency signal to a moving vehicle also equipped with at least one transceiver (rf tag), referred to as the “Responder.” The challenger functionality can be included in or associated with a police radar gun so that data (e.g., VIN, registration, compliance) is also provided to the challenger together with vehicle speed info.

In accordance with another feature of the present invention, the Challenger functionality can also be integrated with tollbooth equipment, or can be deployed throughout communities at various intersection, bridges, overpasses, etc.

In accordance with another feature of the present invention, the Responder can include an RF transceiver (such as an RF tag) associated with the VIN plate.

In accordance with yet another feature of the present invention, additional RF tags can be deployed in a network throughout a vehicle with status and reporting coordinated by, with or through the Main Responder tag.

In accordance with a feature of the present invention, a CPU can assists with Tag coordination. Modern motor vehicles include a CPU (computer board and circuitry) within the engine block. An RF tag can also be integrated with the engine CPU or can coordinate with the engine computer. Use of several tags, including the VIN plate and engine tags can ensure that a motor vehicle's identity is preserved. Thieves will not likely be able to disable vehicle identify capabilities where several, hard to reach, tags are used. All tags can be operable as the Responder.

In accordance with another feature of the present invention, a motor vehicle can be disabled based on at least one of: vehicle location, security status (e.g., theft indicated), or intervention by the owner, lien holder or a third party on the owner's/line holder's behalf. Smart disablement means that a motor vehicle will be directed to stall (cease operation) when it is determined (either by third party resources/services, or preprogrammed network equipment associated with a service) that the vehicle is in a safe mode (e.g., less than 5 MPH) or location (e.g., out of heavy traffic or congested areas).

In accordance with Distributed Tagging can be used to provide operational readiness/status/feedback to main computer assets in a motor vehicle. Vehicle-based tag communications can operate using the Bluetooth standard, or other RF protocols.

### BRIEF DESCRIPTION OF THE DRAWINGS

The novel features believed characteristic of this invention are set forth in the appended claims. The invention itself, however, as well as a preferred mode of use, further objects, and advantages thereof, will best be understood by reference to the following detailed description of an illustrative embodiment when read in conjunction with the accompanying drawings, wherein:

FIG. 1 illustrates a system architecture for supporting a radar gun initiated vehicle mounted rf tag challenge.

FIG. 2 illustrates a vehicle identification sticker (VIN) and includes an example of architectural layout of circuitry used for incorporating rf tagging technology with VIN stickers and plates (e.g., physical tags).

FIG. 3 Also shows VIN stickers and illustrates media that can be used to carry electronic circuitry within registration stickers or license plates.

FIG. 4 illustrates a aspects of information that can be retrieved from tags utilizing a handheld units having a similar footprint to current handheld radar guns used solely for determining speed. Also show is utilizing of printing technology to provide a rendering of information retrieved in accordance with aspects of the present invention.

FIG. 5 Illustrates retrieved information that can be and organized in a radar data pack.

FIG. 6 illustrates a network of users and information databases that can be accessed to retrieve information associated with a vehicle's rf tag identification.

### DETAILED DESCRIPTION OF THE INVENTION

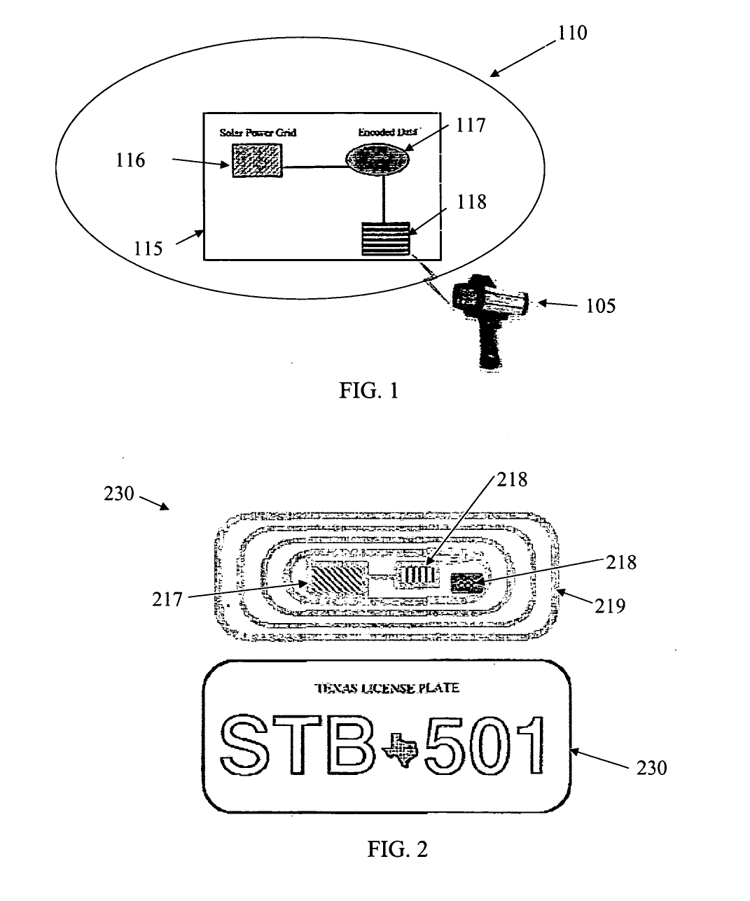

Referring to FIG. 1, illustrates the system architecture for supporting a radar initiated vehicle mounted rf tag challenger, which can be referred to as a “challenging system”. As shown in the FIG. 1, a radar source 105 (which can be referred to as the “challenger”) transmits a signal towards a vehicle 110, which contains an rf tag 115 mounted therein. The rf tag 115 includes a power source 116, a memory 117 with encoded data and a transceiver 118 for receiving the radar challenge from the radar source 101 and transmitting data from the memory with encode data 117 back to the radar source 101. The power source 116 can include a battery, solar powered cell, vehicle power connection, or any combination thereof. The radar tag electronic can includes components and circuitry known in the art, but must have a memory carrying relevant data, transceiver for receiving a challenge and transmitting data and power source.

It should be appreciated that the rf tag 115 can be mounted within the vehicle in a similar fashion that toll tags are mounted (i.e., adhered inside the windshield); however, easily removable tags may defeat reporting objectives. The rf tag can also be mounted in association with a vehicles VIN tag, license plate(s) or registration/inspection stickers. The rf tags can be installed in a manner that proves difficult to remove. During vehicle manufacturing, for example, an rf tag can be integrated within the vehicle in a manner that makes it difficult for the tag to be removed. The tag can be supplied as part of a vehicle license plate, which is issued by a government entity. Because of their small for factor, some tags can be integrated within or behind registration/inspection stickers, so long a an adequate power source is available.

Referring to FIG. 2, illustrated a radar data electronic inlay 200, including a power source 216, memory 217 and transceiver 218 and antenna 219. The radar data electronic inlay can be adhered or mounted to the back of a license plate 230 or inspection sticker 230, depending on its size/profile.

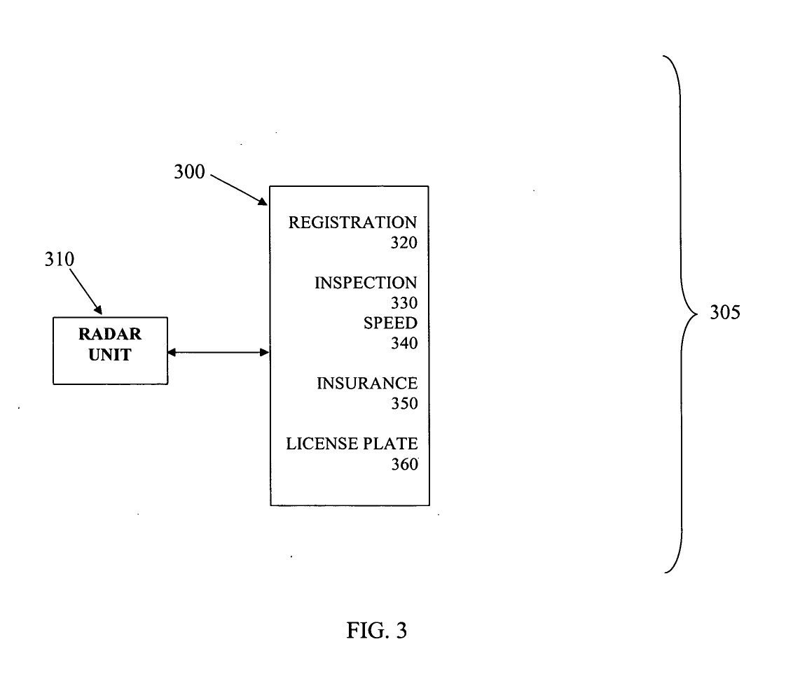

FIG. 3 illustrates a chart 300 of data that can be retrieved from an rf tag 310 carried by a motor vehicle. The rf tag 310 can provide a challenging radar unit 305 (e.g., a radar gun used by law enforcement) with vehicle registration data 320, vehicle inspection data 330, insurance status 340, and vehicle identification information 350. The radar unit can also obtain a vehicle's speed 360 during the radar challenge.

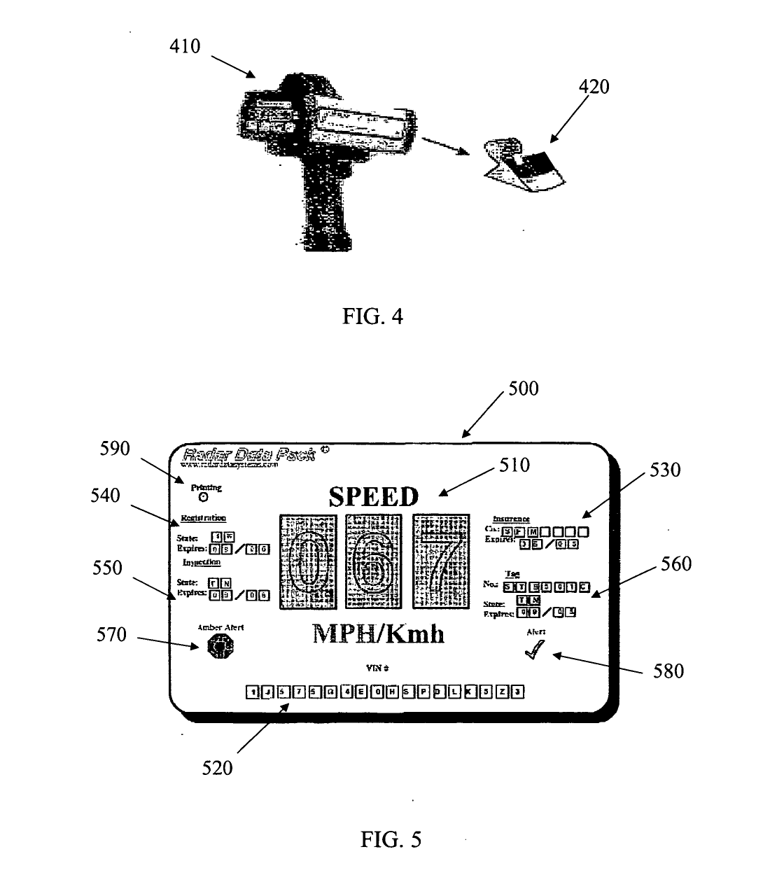

FIG. 4 illustrates a radar unit 410 and a printer 420. I can be appreciated given this disclosure that information retrieved using a radar unit 410 is extensive and would be best provided in printed form. For this reason, the present inventors describe the use of a printer to render information retrieved by the radar unit 410. Utilizing portable printing technology (i.e., thermal printers), an officer can create a record of vehicle data. A carbon copy can be given to the arrested individual, while the original can remain in the record. For example, the printed information can be attached to a copy of any traffic ticket that may be issued to the arrested driver.

FIG. 5 Illustrates retrieved information that can be and organized in a radar data pack 500. The Radar Data Pack, as shown in FIG. 5 provides an organized summary of information retrieved using the present invention. The radar data pack is a display integrated with the radar unit, whether the radar unit is hand held or vehicle mounted, which shows the officer the status of information retrieved from the vehicle after a challenge. As shown in the radar data pack 500, the display will show the vehicles speed 510, vehicle identification number (VIN) 520, insurance information 530, state registration information 540, inspection information 550, license tag/plate information 660, and amber alert information 570. The amber alert may become active if the vehicle has been identified by a license plate number or VIN. Another alert warning 580 can be provided on the display to indicate additional warnings that should be made aware to the arresting officer, such as vehicle theft, criminal records of drivers etc. A printing indicator 590 can show the status of the unit's printing to the associated printer.

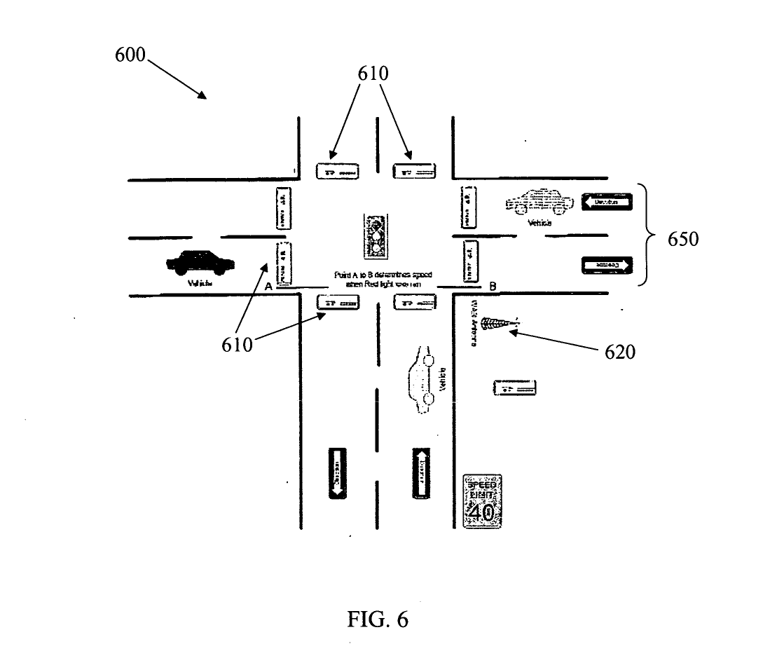

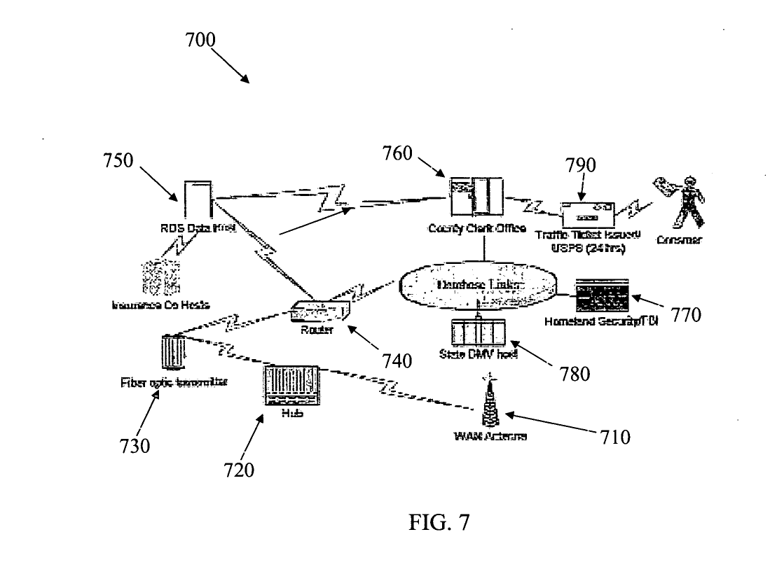

FIG. 6 illustrates a major intersection 600 wherein radar challenging units 610 are located along vehicle pathways 650 going into and out of the intersections. The radar challenging units 610 can be co-located with street light hardware (not shown). The radar units 610 can be deployed at either end of the pathway, although units are shown in the diagram deployed at every entry and exit around the intersection. Vehicles are challenged as they pass through the intersection. The radar units 610 deployed around an intersection 600 can be used, for example, to detect red light violations. Information about red light violations would include the vehicles identification that is retrieved during the challenge. With this information, a ticket or warning can be issued to the driver. Such automation can provide for issuance within 72 hours of the violation. The intersection radar units 610 can also help track a vehicles location as it move about a city. All information retrieved from the radar units 610 at the intersection can be transmitted using telecommunications hardware (wired or wireless) over data networks to agencies interested in the information (.e.g., motor vehicle department, law enforcement, insurance agencies, homeland security department). The information can be transmitted wirelessly using, for example, a WAN antenna 620. Other wired and wireless network known in the are can be used to route information.

It should be appreciated that the radar units can also be deployed along major streets. Inlayed Street Tracking Units can be located along city streets as a network to provide adequate coverage of commonly traveled areas. Inlayed Street Tracking units are embedded in the street at the point of the street light with the electronic tracking device scanning all vehicles that pass above the data collection device that are less than 6′ where the license plate has the RDP sticker on the license plate. The present system can cooperate with global positioning satellite (GPS) tracking to provide the ability to locate vehicles by uploading the data from the RDP system to a database utilizing GPS tracking to monitor vehicles movements. It should also be appreciated that information from the system can be provided for a fee to private parties. For example, shipping firms may benefit from data retrieved by the system regarding a vehicles location. A challenger can collects data from a an associated interstate/intrastate database file and can track the movement of the vehicle throughout the state after a challenger in the field within that state retrieves data. This data can be uploaded (for a fee) to the proper authorities for a form of grid co-ordinance to estimate the location of the vehicle.

Along the interstate lanes, Challengers can be provided in the form of Highway Tracking units are elevated over the highway with the electronic tracking device scanning all vehicles that pass under the data collection device. This information is then transferred via wide area network (WAN) the a main data collection unit and then sent to the proper authorities.

Along the city streets, Challengers can be provided in the form of Inlayed Street Tracking units are embedded in the street at the point of the street light with the electronic tracking device scanning all vehicles that pass above the data collection device that are less than 6′ where the license plate has the tag-enabled sticker on the license plate. Whereas the state has the month and year of the registration on the physical tag. This information is then transferred via wide area network (WAN) the a main data collection unit above the signal light and then sent to the proper data collection unit. The data collection database then cross-references with the city clerk department of motor vehicles, matches the data and flags the owner of the vehicle. A traffic ticket is then generated and mailed to the owner of the vehicle's owner indicating that the vehicle ran a red light on X date and time, for example, with 48 hours of the incident. This can also be implemented at certain stop signs that the agency dictates. This is a cost effective measure that overrides the current “picture” of the license plate scenario that is currently in some major cities.

Referring to FIG. 7, a network architecture 700 is shown that can be used to support reporting of information retrieved from a radar system. The network 700 can include a WAN antenna 710 (or the like), a hub 720, fiber optic transmitter 730, and a router 740. The data is routed by the router 740 via networks to end client enterprise equipment, such as that shown for the insurance company 750, counter clerk office 760, homeland security department 770, and state departments of motor vehicles 780. The Country Clerks office 760, for example, may be the government entity responsible for issuing tickets/citations 790 to vehicle owners.

The following is a partial list of activities/users that can benefit from the present invention:
State Trouper Agencies
City Law Enforcement Agencies
Vehicle Insurance Agencies
Amber Alert
Homeland Security
Inter-country Tracking
Auto Rental Agencies

There are two aspects to the Radar Data Pack design process: the physical design of the retro fit to the existing field units, and the design of the programmable code content. The aim is to offer a fast, easy to follow, quick to implement and effective way of delivering the information required to effect a successful operation. The unit will be designed in accordance with the individual application and the profile of the user in terms of, requirements, interests and abilities.

The embodiments and examples set forth herein are presented in order to best explain the present invention and its practical application and to thereby enable those skilled in the art to make and utilize the invention. However, those skilled in the art will recognize that the foregoing description and examples have been presented for the purpose of illustration and example only. The description as set forth is not intended to be exhaustive or to limit the invention to the precise form disclosed. Many modifications and variations are possible in light of the above teaching without departing from the spirit and scope of the following claims.

1. A system for wirelessly determining motor vehicle data, comprising a radar unit operating as a challenger that causes rf tags mounted within motor vehicles to respond to the radar unit by transmitting data stored in the rf tags about motor vehicles including at least one of state registration status, licensed plate identification, vehicle identification number (VIN), vehicle inspection status, insurance status, amber alert status.

2. The system of claim 1 further comprising an rf tag mounted within a motor vehicle, said rf tag including a memory, power source and transceiver that is responsive to radar signals, said rf tag for providing data stored in the rf tag about the vehicle, including at least one of state registration status, licensed plate identification, vehicle identification number (VIN), vehicle inspection status, insurance status, amber alert status.

3. The system of claim 1 wherein the tag can provide vehicle location information useful for determining the vehicle location and speed in association with its initiation with location data obtained by prior radar units.

4. The system of claim 2 wherein the tag can provide vehicle location information useful for determining the vehicle location and speed in association with its initiation with location data obtained by prior radar units.

5. The system of claim 1 wherein data received from rf tags is processed by the radar unit and transmitted to interested government and/or private entities via communications networks.

6. The system of claim 2 wherein data received from rf tags is processed by the radar unit and transmitted to interested government and/or private entities via communications networks.

7. The system of claim 1 wherein the radar unit is integrated with a law enforcement radar system adapted to obtain vehicle speed information in addition to the vehicle-related data.

8. The system of claim 7 wherein data received from rf tags and vehicle speed information retrieved by the radar unit is processed by the radar unit and transmitted to interested government and/or private entities via communications networks.

9. The system of claim 7 wherein data received from rf tags and vehicle speed information retrieved by the radar unit is processed by the radar unit and formatted for printing by a printer placed in communication with the radar unit.

10. The system of claim 7 wherein data received from rf tags and vehicle speed information retrieved by the radar unit is processed by the radar unit and formatted for display on a screen integrated with the radar unit.

11. A system for wirelessly providing motor vehicle data to a challenging radar unit, comprising an rf tag mounted within a motor vehicle, said rf tag including a memory, power source and transceiver that is responsive to radar signals, said rf tag further adapted for providing data stored in the rf tag about the vehicle, including at least one of state registration status, licensed plate identification, vehicle identification number (VIN), vehicle inspection status, insurance status, amber alert status.

12. The system of claim 11 further comprising a radar unit operating as a challenger that causes rf tags mounted within motor vehicles to respond to the radar unit by transmitting data stored in the rf tags about motor vehicles including at least one of state registration status, licensed plate identification, vehicle identification number (VIN), vehicle inspection status, insurance status, amber alert status.

13. The system of claim 11 wherein the tag can provide vehicle location information useful for determining the vehicle location and speed in association with its initiation with location data obtained by prior radar units.

14. The system of claim 11 wherein the tag can provide vehicle location information useful for determining the vehicle location and speed in association with its initiation with location data obtained by prior radar units.

15. The system of claim 11 wherein data received from rf tags is processed by the radar unit and transmitted to interested government and/or private entities via communications networks.

16. The system of claim 12 wherein data received from rf tags is processed by the radar unit and transmitted to interested government and/or private entities via communications networks.

17. The system of claim 11 wherein the radar unit is integrated with a law enforcement radar system adapted to obtain vehicle speed information in addition to the vehicle-related data.

18. The system of claim 17 wherein data received from rf tags and vehicle speed information retrieved by the radar unit is processed by the radar unit and transmitted to interested government and/or private entities via communications networks.

19. The system of claim 17 wherein data received from rf tags and vehicle speed information retrieved by the radar unit is processed by the radar unit and formatted for printing by a printer placed in communication with the radar unit.

20. The system of claim 17 wherein data received from rf tags and vehicle speed information retrieved by the radar unit is processed by the radar unit and formatted for display on a screen integrated with the radar unit.

21. A system for wirelessly determining motor vehicle data, comprising:
a radar unit operating as a challenger that causes rf tags mounted within motor vehicles to respond to the radar unit by transmitting data stored in the rf tags about motor vehicles including at least one of state registration status, licensed plate identification, vehicle identification number (VIN), vehicle inspection status, insurance status, amber alert status; and
at least one rf tag mounted within a motor vehicle, said rf tag including a memory, power source and transceiver that is responsive to radar signals, said rf tag for providing data stored in the rf tag about the vehicle, including at least one of state registration status, licensed plate identification, vehicle identification number (VIN), vehicle inspection status, insurance status, amber alert status.

22. The system of claim 21 wherein the tag can provide vehicle location information useful for determining the vehicle location and speed in association with its initiation with location data obtained by prior radar units.

24. The system of claim 21 wherein data received from rf tags is processed by the radar unit and transmitted to interested government and/or private entities via communications networks.

25. The system of claim 22 wherein data received from rf tags is processed by the radar unit and transmitted to interested government and/or private entities via communications networks.

26. The system of claim 21 wherein the radar unit is integrated with a law enforcement radar system adapted to obtain vehicle speed information in addition to the vehicle-related data.

27. The system of claim 26 wherein data received from rf tags and vehicle speed information retrieved by the radar unit is processed by the radar unit and transmitted to interested government and/or private entities via communications networks.

28. The system of claim 26 wherein data received from rf tags and vehicle speed information retrieved by the radar unit is processed by the radar unit and formatted for printing by a printer placed in communication with the radar unit.

29. The system of claim 26 wherein data received from rf tags and vehicle speed information retrieved by the radar unit is processed by the radar unit and formatted for display on a screen integrated with the radar unit.
